(19) United States
(12) Patent Application Publication
(10) Pub. No.: US 2008/0150893 A1
(43) Pub. Date: Jun. 26, 2008

(54) TWO-FOOT OPERATED MOUSE

(76) Inventor: Yair Ofer, (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/614,150

(22) Filed: Dec. 21, 2006

(51) Int. Cl. G06F 3/033

(52) U.S. Cl. 345/157

(57) ABSTRACT

The present invention offers a two-foot operated device for controlling the movement of a computer cursor, wherein the first foot rotates a first roller to control the horizontal movement of said cursor and the second foot rotates a second roller to control the vertical movement of said cursor.

### BACKGROUND OF THE INVENTION

1. Field of the Invention

The present invention relates generally to foot operated computer mice and more specifically, it relates to a two-foot operated mouse for controlling the movement of the cursor using both feet.

2. Description of the Related Art

Use of a conventional, manually operated pointing device, also known as a mouse, to move a cursor on a display monitor may cause fatigue and pain to the wrist and arm of the user. Prolonged use of a manual mouse may even cause injuries related to repetitive movement and strain.

As an alternative to using a manual mouse, one may use a foot-operated mouse. It can be appreciated that foot operated computer mice have been in use for years. Typically, foot operated computer mice include foot-movement sensing pads, foot pedals, foot mice that require the use of only one foot, foot track rolls, etc. Illustrative of such attempts are U.S. Pat. No. 5,907,319, U.S. Pat. No. 6,611,250, U.S. Pat. No. 6,091,402, and U.S. Pat. No. 6,600,477, which each provide mouse assemblies that require single foot operation to execute mouse manipulations and WO0214970 and EP1309903, which feature foot-operable computer input control devices that enables interaction with a computer game. Such devices may be useful for reducing the risk of injuries associated with repetitive motions.

However, a primary problem presented by conventional foot operated computer mice is that they do not make use of both feet, resulting in the asymmetric use of one foot over another.

Another problem with conventional foot operated computer mice is that they are expensive, and yet another problem with conventional foot operated computer mice is that they limit foot movement.

In these respects, the two-foot operated mouse according to the present invention substantially departs from the conventional concepts and designs of the related art, and in so doing, provides an apparatus primarily developed for the purpose of controlling the movement of the cursor using both feet.

### SUMMARY OF THE INVENTION

In view of the foregoing disadvantages inherent in the known types of foot operated computer mice, the present invention provides a new two-foot operated computer mouse construction wherein said two-foot operated mouse can be utilized for controlling the movement of a computer cursor using both feet substantially simultaneously.

The general purpose of the present invention, which will be described subsequently in greater detail, is to provide a new two-foot operated mouse that has many of the advantages of the foot operated computer mice mentioned heretofore and has many novel features that result in a new two-foot operated mouse that is not anticipated, rendered obvious, suggested, or even implied by any of the previous foot operated computer mice, either alone or in any combination thereof.

To attain this goal, the present invention generally comprises a housing containing two rollers, two wheels, two shafts, two disks, two electronic sensors, and a processing chip, with a connecting cable for connecting the two-foot operated mouse to a central processing unit. The user places each foot on a roller and moves his feet back and forth, turning the rollers. One roller may be in charge of motion in the X direction, and the other roller may be in charge of motion in the Y direction. The computer cursor will move to the coordinates identified as the combination of the X and Y directional movements. The rollers in turn move a pair of wheels. Each wheel turns a shaft that has, for example, a disk with indentations. When the roller rolls, the shaft and disk rotate. Electronic sensors detect the movement and generate corresponding electronic signals. A processing chip translates the electronic signals into a computer-based language and sends the data to the computer via, for example, a connecting cable. The cable connects the device to the computer through, for example, a USB port. The device comes equipped with means for entering click commands.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of the description and should not be regarded as limiting.

A primary object of embodiments of the present invention is to provide a two-foot operated mouse that will overcome the shortcomings of the prior art devices.

Another object of embodiments of the present invention is to provide a two-foot operated mouse for controlling the movement of the cursor using both feet.

Another object of embodiments of the present invention is to provide a two-foot operated mouse that enables the user to work on the computer with out having to remove his fingers from the keyboard.

Another object of embodiments of the present invention is to provide a two-foot operated mouse that encourages the user to move his feet while working on the computer, thus promoting exercise and health.

Another object of embodiments of the present invention is to provide a two-foot operated mouse that reduces user stress due to the texture of the device and the type of movement required to operate said device.

Another object of embodiments of the present invention is to provide a two-foot operated mouse that prevents the decline in typing speed associated with frequent movement of the hands between the keyboard and the mouse, thus increasing worker productivity.

Another object of embodiments of the present invention is to provide a two-foot operated mouse that allows the user to choose between working with the regular mouse, the two-foot operated mouse, or both together.

Other objects and advantages of the present invention will become obvious to the reader and it is intended that these objects and advantages be within the scope of the present invention,

In order to accomplish the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a perspective view of a two-foot operated mouse according to an embodiment of the present invention;

FIG. 2 is a perspective view of the two-foot operated mouse of FIG. 1 with the cover removed, according to an embodiment of the present invention; and

FIG. 3 is an environmental perspective view of the two-foot operated mouse of FIG. 1, according to an embodiment of the present invention;

FIG. 4 is a schematic diagram of the two-foot operated mouse of FIG. 1, according to an embodiment of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF EMBODIMENTS OF THE INVENTION

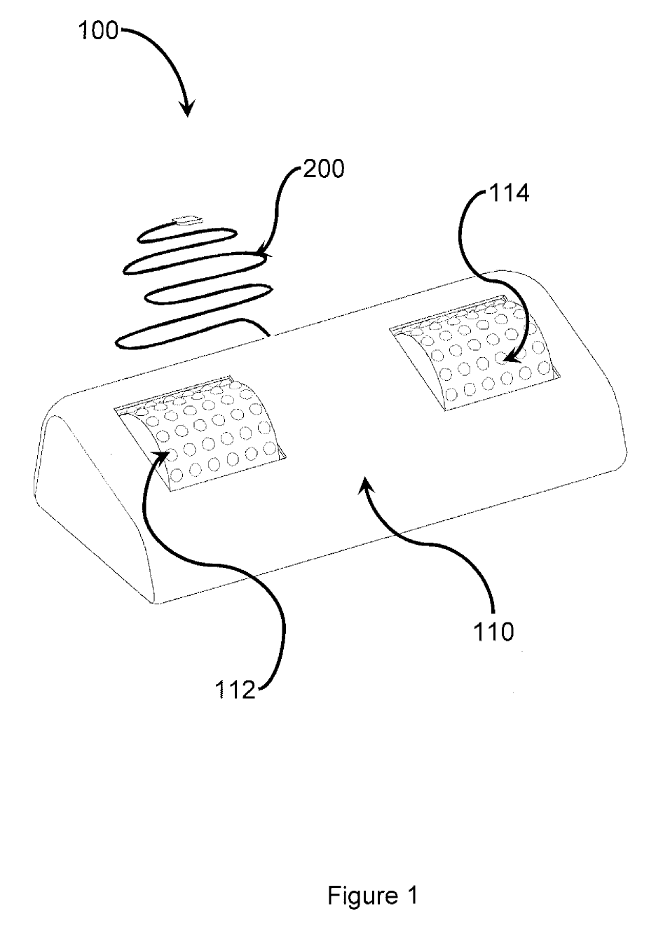

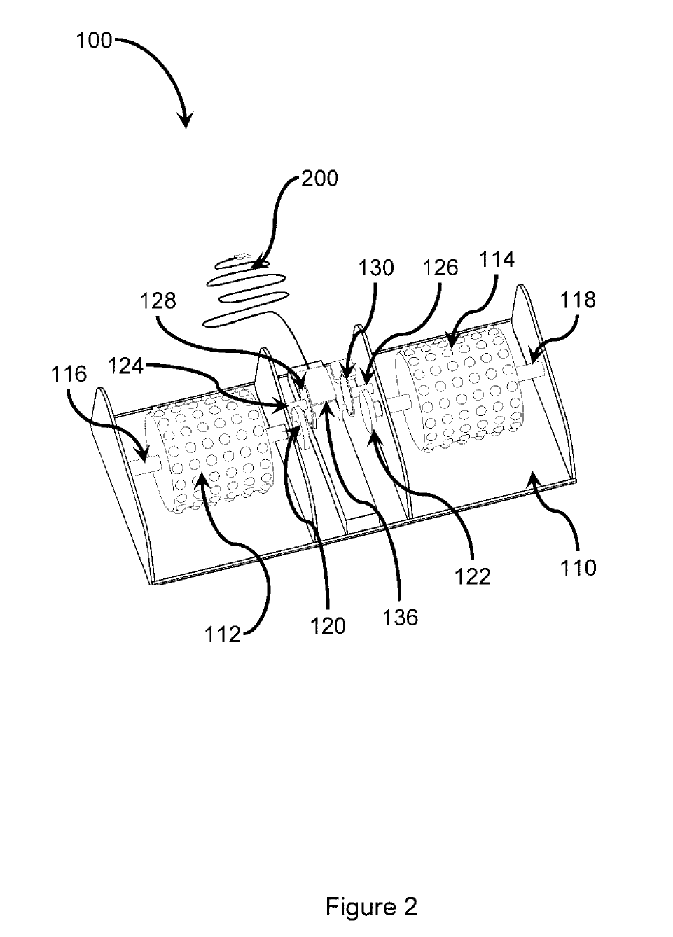

Turning now descriptively to the drawings, in which similarly referenced characters denote similar elements throughout the several views, the attached figures illustrate a two-foot operated mouse (100), which comprises a housing (110) that contains therein a first roller (112, a second roller 114), a first wheel(120, a second wheel 122), a first shaft (124, a second shaft 126), a first disk (128, a second disk 130), a first sensor (132, a second sensor 134), a processing chip (136), and a connecting cable (200) for connecting two-foot operated mouse (100) to a central processing unit or CPU (202). A two-foot operated mouse (100) according to an embodiment of the present invention is shown in FIG. 1. FIG. 2 describes the same embodiment with the cover of housing (110) removed in order to show an arrangement of the components therein.

According to embodiments of the present invention, movements of the user's feet (208) on first and second rollers (112, 114) are transmitted via first and second wheels (120, 122) to first and second electronic sensors (132, 134), which translate said movements into electrical signals communicated to a central processing unit (CPU) (202) that controls the movement of a computer cursor seen on a computer monitor (206).

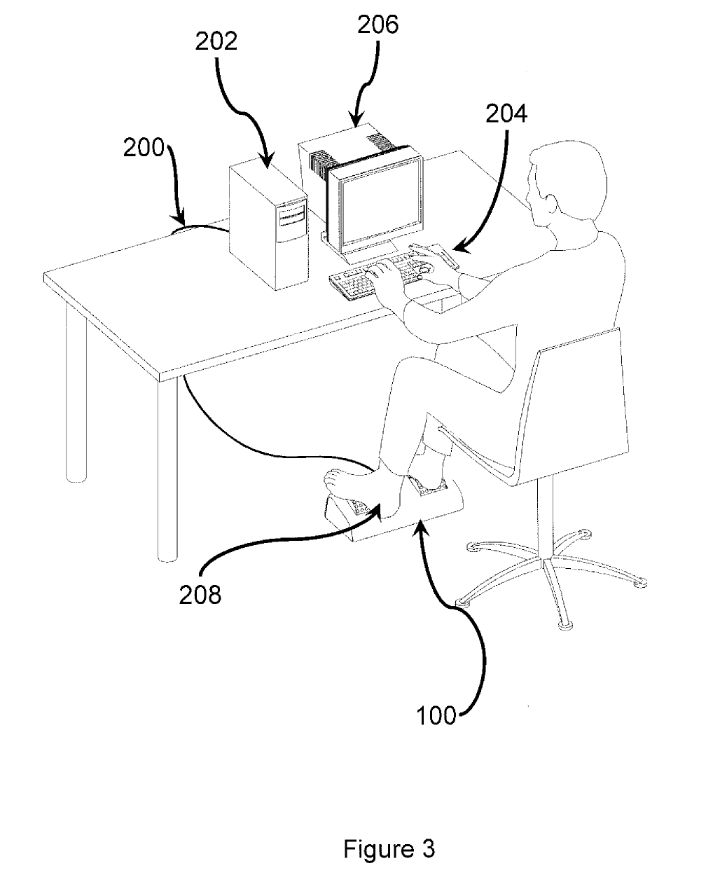

Embodiments of two-foot operated mouse (100) may be placed, for example, on the floor or near the user's feet (208). An example of such an arrangement is shown in FIG. 3. Because operation of the present invention requires the use of both feet (208), the user is active while working on the computer, thus improving circulation and promoting exercise and health.

Furthermore, by using a two-foot operated mouse (100) according to the present invention, the user may be able to increase keyboard productivity, as he no longer needs to remove his hands from a keyboard (204) to manipulate a manually operated mouse.

An embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment” , “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting and is for descriptive purpose only.

The principles and uses of the teachings of the present invention may be better understood with reference to the accompanying description, figures, and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein is not to be construed as excluding additional components, steps features, integers or groups thereof but rather that the additional features, integers, steps, components or groups thereof do not materially after the basic and novel characteristics of the claimed composition, device or method.

If the specification or claims refer to “an additional” clement that does not preclude there being more than one of the additional element.

It is to be understood that where the claims or specification refer to “a” or “an” element, such reference is not to be construed as there being only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof selected steps or tasks.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods, and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

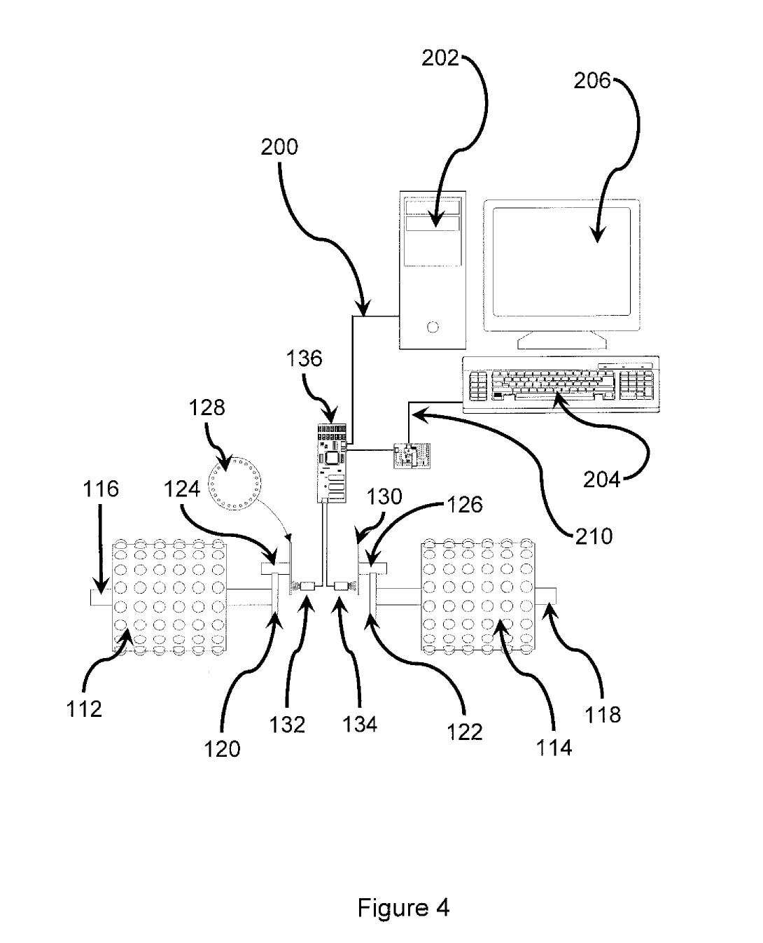

Reference is now made to FIG. 4, which provides a schematic diagram of the two-foot operated mouse (100) according to an embodiment of the present invention. Housing (110) encompasses the invention and holds within it the additional components. First and second rollers (112, 114), first and second wheels (120, 122), first and second sensors (132, 134), first and second shafts (124, 126), first and second disks (128, 130), and processing chip (136), are arranged within housing (110).

Housing (110) may be placed on the floor, or other location, where the user is able to reach two-foot operated mouse (100) with his feet (208). To operate two-foot operated mouse (100), the user places his feet (208) on first and second rollers (112, 114), which are located within and protrude Lip from the top part of housing (110).

A first roller (112) provides a surface for engaging, for example, a left foot (208) of a user. First roller (112) may be disposed on, for example, the left side of housing (110), and rotatably suspended therein. A second roller (114) provides a surface for engaging, for example, a right foot (208) of a user. Second roller (114) may be disposed on, for example, the right side of housing (110), and rotatably suspended therein.

The user places each foot (208) on a roller (112, 114) and moves his feet (208) back and forth in order to turn first and second rollers (112, 114) according to where he desires the cursor to be positioned on the computer monitor (206). The direction of the movement of the user's foot (208) may correspond to the direction of movement of first and second rollers (112, 114). First roller (112) may be in charge of motion in, for example, the X direction, and second roller (114) may be in charge of motion in, for example, the Y direction. The cursor moves to the coordinate that is, for example, a combination of those X and Y direction movements. Thus the substantially simultaneous movement of first roller (112) and second roller (114) results in the control of the cursor.

According to some embodiments, first and second rollers (112, 114) are substantially cylindrical in shape, although other shapes may also be used.

According to some embodiments of the present invention, the surfaces of first and second rollers (112, 114) may have, for example, a knobby or bumpy texture that serves to massage the feet (208) of the user as first and second rollers (112, 114) are rotated by feet (208). Such a massaging action promotes improved circulation in the feet (208) and legs of the user, which promotes overall improved health and increased energy.

According to embodiments, first wheel (120) communicates with first roller (112) along a first common axis (116). A second wheel (122) communicates with second roller (114) along a second common axis (118). When first or second rollers (112, 114) are rotated by feet (208), first and second wheels (120, 122) rotate accordingly.

A first shaft (124) is mounted substantially perpendicular to and is engaged by first wheel (120). A second shaft (126) is mounted substantially perpendicular to and is engaged by second wheel (122). Said engagements may be accomplished, for example, by use of friction gearing. When first or second wheels (120, 122) are rotated, first and second shafts (124, 126) rotate accordingly.

According to embodiments of the present invention, the difference in the diameters of first and second wheels (120, 122) and corresponding first and second shafts (124, 126) creates a gear shift mechanism. By changing these diameter ratios, two-foot operated mouse (100) can be made more or less sensitive to the movements of each of the user's feet (208).

A substantially circular, flat first disk (128) is mounted at the end of first shaft (124), substantially perpendicular to first shaft (124). The circumference of one surface of first disk (128) may be inscribed with, for example, dimples or depressions arranged in a regular pattern. A substantially circular, flat second disk (130) is mounted at the end of second shaft (126), substantially perpendicular to second shaft (126). The circumference of one surface of second disk (130) may be inscribed with, for example, dimples or depressions arranged in a regular pattern. When first or second shafts (124, 126) are rotated, first and second disks (128, 130) also rotate accordingly.

A first and a second electrical sensor (132, 134) detect the rotational movement of first and second disks (128, 130) respectively. This detection may be accomplished by, for example, reading the motion of the inscribed dimples on the circumference of first and second disks (128, 130) and translating that physical motion into electronic signals. First electrical sensor (132) is situated within housing (110) such that first electrical sensor (132) communicates with first disk (128). Second electrical sensor (134) is situated within housing (110) such that second electrical sensor (134) communicates with second disk (130). First and second electrical sensors (132, 134) may be any type of sensors that are able to detect the motion of first and second disks (128, 130) respectively.

A processing chip (136) receives the electronic signals from both first and second sensors (132, 134) and translates these signals into a computer-based language in order to determine the vertical and horizontal direction of movement desired of the cursor. Processing chip (136) may interpret the signals from first sensor (132) as, for example, horizontal movement and the signals from second sensor (134) as, for example, vertical movement. Processing chip (136) then transmits that data to CPU (202). Processing chip (136) is operatively connected to CPU (202) via, for example, a connecting cable (200), and communicates the movement data to CPU. (202).

According to some embodiments, processing chip (136) may further integrate the data received from first and second sensors (I32, 134) with, for example, clicking commands generated by keyboard (204). Processing chip (136) may then translate that information into a computer-based language and transmit it to CPU (202).

Two-foot operated mouse (100) may be operatively connected to CPU (202) by, for example, a connecting cable (200) that uses, for example, USB connections.

According to some embodiments, two-foot operated mouse (100) may be further equipped with means for entering click commands. For example, one or more buttons or pedals may be located, for example, next to or above first and second rollers (112, 114), and the clicking action may be executed by, for example, depressing a button or pedal with a foot (208).

According to some other embodiments, other means for entering click commands may be provided. For example, at least one key on a regular keyboard (204) may be programmed to perform the clicking commands corresponding to, for example, the right or left buttons on a hand operated mouse; or a separate keyboard or clicking tool equipped with at least one preprogrammed key may be placed in close proximity to keyboard (204); or a specially designed keyboard may be equipped with at least one additional key specifically designated to perform at least one clicking command.

According to some embodiments, keyboard (204) or another clicking means may be connected to two-foot operated mouse (100) by a second cable (210) that transmits the clicking commands, for example, processing chip (136).

According to some embodiments of the present invention, two-foot operated mouse (100) of the present invention may work simultaneously with, for example, a manually operated mouse. Such an option may be especially useful when, for example, playing computer games.

According to some embodiments of the present invention, there may be a control device such as, for example, a button or switch, located on two-foot operated mouse (100) of the present invention for disabling the connection between rollers (112, 114) and the computer cursor. Said connection may be disabled by, for example, disabling the electronic connection to two-foot operated mouse (100). According to such an embodiment, when the user activates said control device, he may use rollers (112, 114) to, for example, massage his feet (208).

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A two-foot operated device for controlling the movement of a computer cursor, wherein the foot movement is translated to electrical signals for controlling the cursor, said device comprised of:
a first roller to control the horizontal movement of said cursor and
a second roller to control the vertical movement of said cursor,
wherein cursor movement is controlled by moving both rollers simultaneously.

2. The device of claim 1, wherein the surface of said rollers have a knobby, message-producing texture.

3. The device of claim 1, further equipped with sensors that detect the motion of said rollers and generate electronic signals for transmission to a central processing unit.

4. The device of claim 1, operatively associated with a keyboard that has at least one key for selecting data and objects on a computer monitor, wherein
said at least one key operates in conjunction with the movement of the first and second rollers, and
said at least one key is manually operated.

5. The device of claim 1, operatively associated with a device with at least one key for selecting data and objects on a computer monitor, wherein
said at least one key operates in conjunction with the movement of the first and second rollers, and
said at least one key is foot-operated.

6. The device of claim 1, further comprising at least one key for selecting data and objects on a computer monitor, wherein
said at least one key operates in conjunction with the movement of the first and second rollers, and
said at least one key is foot-operated.

7. The device of claim 1 further comprising a control device, wherein, upon activating said control device, the connection between the rollers and the cursor is disabled.

8. The device of claim 1 wherein the interaction between the foot and the roller effects blood circulation.

9. A method for controlling a computer cursor with a two-foot operated device, wherein
a first roller is moved by a first foot to control the horizontal movement of said cursor and
a second roller is moved by a second foot to control the vertical movement of said cursor.
said foot movements are translated to electrical signals for controlling the cursor, and
said movement of both rollers simultaneously control said cursor.
